(19) United States
(12) Patent Application Publication
(10) Pub. No.: US 2026/0128601 A1
(43) Pub. Date: May 7, 2026

(54) SOLAR-POWERED PORTABLE ELECTRONIC SYSTEMS WITH INTEGRATED, ARTICULATED, AND DOCK-BASED ENERGY MANAGEMENT ARCHITECTURES

(71) Applicant: Patrick Brenner, HOUSTON, TX (US)

(72) Inventor: Patrick Brenner, HOUSTON, TX (US)

(21) Appl. No.: 19/378,156

(22) Filed: Nov. 3, 2025

Related U.S. Application Data
(60) Provisional application No. 63/715,635, filed on Nov. 3, 2024.
(60) Provisional application No. 63/791,448, filed on Apr. 19, 2025.
(60) Provisional application No. 63/904,781, filed on Oct. 24, 2025.

(51) Int. Cl. H02J 7/35; H02J 7/00; H02S 10/20; H02S 10/40; H02S 20/32; H02S 30/10; H02S 30/20; H02S 40/38; H02S 40/42

(52) U.S. Cl. CPC H02J 7/35; H02J 7/731; H02J 7/82; H02S 10/20; H02S 10/40; H02S 20/32; H02S 30/10; H02S 30/20; H02S 40/38; H02S 40/425; H02J 2101/25; H02J 2207/30

(57) ABSTRACT

A modular solar-powered energy system for various electronic devices is disclosed. The system includes detachable solar panels, compact energy storage modules, articulated deployment mechanisms, and intelligent charge management circuitry. It enables complete or partial device operation from ambient light, reducing dependence on wired power. In various embodiments, portable devices integrate laminated or co-encapsulated solar-battery assemblies, while docking stations incorporate multi-axis adjustable panels, embedded rechargeable batteries, and interfaces for simultaneous multi-device charging. Intelligent control logic monitors light levels, charge status, and device priority to optimize energy distribution and extend runtime. Adaptive functions include automatic low-power transitions, user alerts under low-light conditions, and sensor-assisted solar alignment. Applicable to consumer electronics, wearables, grooming, safety, and IoT devices, the system provides a scalable, autonomous, and sustainable power solution that enhances device reliability and operational efficiency across diverse applications.

### FIELD OF INVENTION

The present invention relates generally to portable electronic devices and systems, and more particularly to solar-powered portable devices that incorporate integrated, articulated, and dock-based solar charging architectures. This invention further encompasses devices and systems that are capable of fully solar-based operation without requiring a wired power interface.

### PRIORITY CLAIM STATEMENT

This application claims the benefit of priority to the following U.S. Provisional patent applications: 1) U.S. Provisional Application No. 63/791,448, filed Apr. 19, 2025; 2) U.S. Provisional Application No. 63/715,635, Filed Nov. 3, 2024; and 3) U.S. Provisional Application No. 63/904,781, filed Oct. 24, 2025.

### BACKGROUND

Portable electronic devices have become ubiquitous across consumer, medical, industrial, and professional sectors. Such devices commonly rely on internal rechargeable batteries for energy, and in most cases, these batteries require regular recharging via wired connections to AC power or USB ports. However, reliance on grid power presents multiple challenges, including the need for constant user intervention, cable clutter, and limited functionality in off-grid or emergency scenarios.

Solar energy harvesting represents a promising avenue for powering such devices. Yet existing solar-powered consumer electronics typically treat solar energy as a secondary or auxiliary input. Solar integration is often implemented in rigid form factors, with limited flexibility in deployment, orientation, or energy management.

Furthermore, few current systems provide intelligent logic for energy prioritization, adaptive behaviour in response to ambient lighting conditions, or modular architectures that support dynamic charging methods such as articulated solar panels or smart docking stations. Accordingly, there exists a long-felt but unmet need for a portable electronic platform that is compact, solar-integrated, environmentally adaptive, and capable of stand-alone or docked operation—optionally eliminating the need for external wired power entirely.

### SUMMARY OF THE INVENTION

The following presents a simplified summary of one or more embodiments of the present disclosure to provide a basic understanding of such embodiments. This summary is not an extensive overview of all contemplated embodiments and is intended to neither identify key nor critical elements of all embodiments, nor delineate the scope of any or all embodiments.

The present disclosure, in one or more embodiments, relates to solar-powered portable devices that incorporate integrated, articulated, and dock-based solar charging architectures. This invention further encompasses devices and systems that are capable of fully solar-based operation without requiring a wired power interface.

In various embodiments, the present invention encompasses solar panels that are integrated into or mounted onto a device housing, optionally, along with thin-profile energy storage systems, adaptive power management logic, and or docking station assemblies equipped with articulated solar panel mounts in various combinations and intelligent multi-device charging functionality.

In one aspect of the invention, a portable electronic device comprises a housing, a solar panel integrated with or affixed to an exterior surface of the housing, and an internal battery electrically coupled to the solar panel and configured to receive, store, and supply solar-generated energy to one or more components of the device. Optional features include user-facing status indicators, alert mechanisms, and fallback operational modes that automatically activate when the available energy drops below a predefined threshold.

In another embodiment, the device incorporates a solar panel that is mechanically deployable, foldable, or detachable, and mounted through one or more articulated mechanisms. The device further includes a thin-profile battery thermally or physically coupled to the solar panel. Smart charging logic, may be configured to prioritize solar input whenever sufficient ambient light is detected and to initiate operational adjustments when illumination becomes inadequate.

In yet another embodiment, the invention provides a docking station for portable electronic devices. The docking station includes an articulated solar panel mount, a solar panel, a charging interface, and optionally, an integrated battery for energy storage. The docking station may support multiple device types and incorporates charge-routing logic as well as automatic solar panel repositioning in response to ambient light measurements.

The invention provides a solar-only device that operates on ambient light harvested through its solar panel and stored within a compact energy storage component, without any wired charging interface and incorporates adaptive operational behaviours and integrated solar-storage modules. This modular framework enables application across various portable device categories and promotes user autonomy, environmental efficiency, and sustainability.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

Unless otherwise indicated, each device or embodiment described herein may include or be operatively coupled to a conventional power cord, cable, or adapter for grid power. The omission of such features from the drawings is for clarity of illustration, as these elements are well.

FIG. 1 Illustrates a solar-powered docking station having a solar panel coupled to an onboard rechargeable battery (712) and an optional uninterruptible power supply (UPS) (752). The device further includes power regulation circuitry, multi-voltage logic (740), DC power ports (716)

FIG. 2 Illustrates a mobile phone having one or more modular solar panels detachably secured to the housing by spherical bearing connectors various optional configurations are shown.

FIG. 2A Illustrates a mobile phone having modular solar panels attached via a sliding hinge arm allowing for lateral movement relative to the device and rotation about the hinge axis.

FIG. 2B Illustrates a mobile phone having three modular solar panels mounted via spherical bearings view shows partial folding into back of device.

FIG. 2C Illustrates a mobile phone having solar panels detached mounted via spherical bearings to operative stand allowing articulation.

FIG. 2D Illustrates a mobile phone having solar panels detached and laying flat on a surface collecting light energy.

FIG. 3 Illustrates a laptop computer incorporating a primary and secondary solar panel attached to electromechanically operative pass-through hinge.

FIG. 3A Illustrates a laptop with solar panels folding into back of device.

FIG. 3B Illustrates a laptop having solar panels detached mounted via spherical bearings to operative stand allowing articulation.

FIG. 3C Illustrates a laptop having solar panels detached and lying flat on a surface collecting light energy.

FIG. 4 Illustrates a tablet with the solar modules detached in various configurations and, showing how panels may rotate or articulate and fold relative to the device housing.

FIG. 4A the 4A view shoes panels folding into back of the device.

FIG. 5 Illustrates a toothbrush having an integrated or attachable solar panel and reserve battery housed within the handle, enabling cordless recharging.

FIG. 6 Illustrates a key-fob device incorporating a solar panel and rechargeable battery suitable for replacing disposable cells.

FIG. 7 Illustrates a smoke detector incorporating a solar panel and rechargeable battery to provide self-sustained power.

FIG. 8 Illustrates a remote control incorporating a solar panel and rechargeable battery for long-term, maintenance-free use.

FIG. 9 Illustrates a router with integrated solar charging, modular hinged expansion panel, and DC charging ports.

FIG. 10 Illustrates a display monitor incorporating a solar panel mounted by a conductive linear hinge and integrated UPS for AC/DC operation.

FIG. 11 Illustrates an embodiment featuring a low-force breakaway connector and flexible cable permitting remote placement of a solar panel for optimal sunlight exposure.

FIG. 12 Illustrates a printer with a solar panel mounted to an articulating hinge arm and operative DC charge ports.

FIG. 13 Illustrates a smart television including solar panels and UPS components for sustained operation during outages.

FIG. 14 Illustrates a microwave oven having a hinged solar panel, integrated battery, and UPS.

FIG. 15 Illustrates a gas range with solar and battery support for piezo ignition elements enabling autonomous ignition during power loss.

FIG. 15A Illustrates control logic for switching between mains power, battery ignition, and manual piezo actuation.

FIG. 16 Illustrates a wall clock including a solar panel and rechargeable battery.

FIG. 17 Illustrates a lamp having a solar panel mounted on an articulating hinge-arm and spherical bearing providing electrical pass-through connectivity.

FIGS. 18 and 18A Illustrates schematic diagrams of solar controller circuitry integrating multiple energy sources (solar, DC, AC) with voltage regulation and battery interfaces.

FIG. 19—Illustrates the power control and auto-switching circuit, including outage detection and control logic between primary AC input and backup battery power.

FIG. 20—Depicts the solar charging configuration, showing the controller connections between external DC/AC battery sources and the internal voltage regulation system.

FIG. 21—Shows the inverter and transfer switch circuitry that enables seamless switching between stored DC power and external AC input during operation.

FIG. 22—Presents the sensing and control circuitry responsible for monitoring power conditions, prioritizing inputs, and maintaining uninterrupted power supply behavior.

FIG. 23—Illustrates the integrated device power control system, including the docking station, onboard battery, and charging interfaces that manage power distribution across the unit.

FIG. 24—Provides a process flow diagram outlining the operational logic for detecting low-light conditions, charging the battery, reducing power consumption, and managing standby states.

### STATEMENT REGARDING DRAWINGS

The drawings are provided for purposes of illustration and to show various possible combinations of inventive features. It should be understood that the invention is not limited to the specific embodiments shown, and that features described or illustrated in connection with one embodiment may be combined with features of other embodiments as defined by the claims. The minimum inventive concept resides in the features recited in the claims, whether presented singly or in combination.

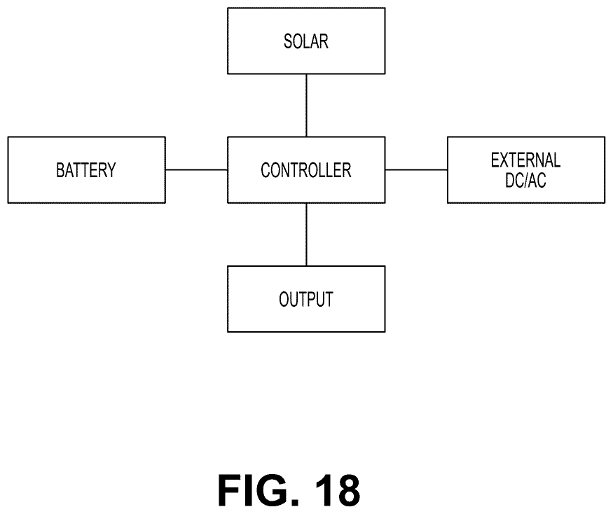

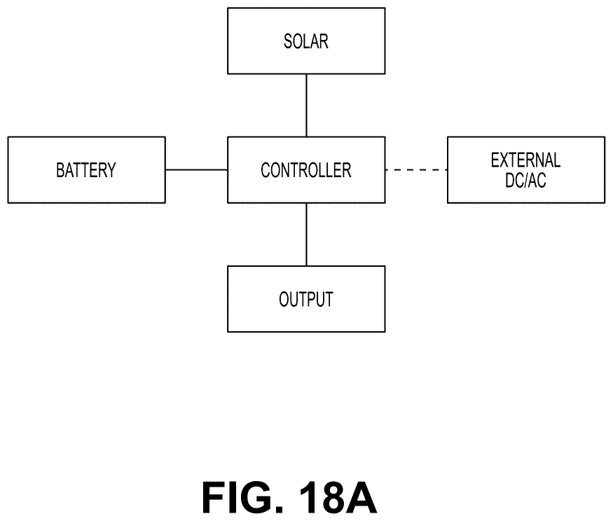

Note: FIGS. 18-24 illustrate various non-limiting logic and control architectures that may be employed, in whole or in part, as desired, to enable functionality in a range of device embodiments. These generalized configurations provide flexible support for solar power integration, battery backup, UPS behaviour, hybrid AC/DC operation, and power management schemes, depending on the needs of a given application.

In various embodiments, the disclosed systems may incorporate a wide range of mechanical and electrical configurations. Components such as solar panels, docking modules, or other deployable elements may be mounted or articulated by one or more hinge assemblies, linkages, or spherical bearings positioned on or within a device housing. Certain implementations may include electrically operative or conductive hinges, low-force breakaway couplings, or protective features such as bumpers, coatings, and edge guards. The system may include one or more features such as foldable or detachable mounts, thermal management structures, or power-control circuitry (e.g., MPPT). These embodiments are illustrative, and numerous combinations and variations are contemplated.

### DETAILED DESCRIPTION

Reference will now be made in detail to some of the present possible embodiments of the invention, examples of which are illustrated in the accompanying drawings. Note that these embodiments are non-limiting in nature. Wherever possible, the same reference numerals are used in the drawings and the description to refer to the same or like parts.

In various embodiments, the invention includes one or more of the following elements, singly or in any combination: deployable, expandable, foldable or detachable solar panels, protective structures; articulating mounting arms and hinge assemblies; spherical bearings; low-force electrical connectors optionally embedded in hinges, such that current carrying elements are part of or may pass through hinges or bearings. Hinges or bearings configured to release without damage; modular or expandable functional sections including solar-harvesting modules with or without MPPT capabilities; and shock-absorbing elements to protect components, screen protecting elements, during deployment, impact, or disconnection. Any of these features may be implemented with any of the device families described herein, unless technically incompatible.

In one general embodiment, the invention relates to a standalone solar-powered portable electronic device that comprises the housing with an integrated solar panel. The solar panel may include monocrystalline or polycrystalline photovoltaic cells configured to convert ambient indoor or outdoor light into electrical energy. The solar panel is electrically coupled to an internal battery or energy storage component that receives and stores the harvested energy. The energy storage component may include a lithium-polymer battery, solid-state battery, or ultracapacitor, selected based on desired parameters such as energy density, cycle life, and thermal stability. This configuration enables continuous or extended device operation without dependence on external charging sources.

In other embodiments, the device may further include additional features such as category-specific support for mobile phones, grooming tools, key fobs, environmental sensors, and flashlights. The device may also include visual or audible alert mechanisms that activate when the stored charge drops below a critical threshold. Status indicators such as LEDs, display icons, or app-based notifications may be employed to indicate charge level and source, whether solar or battery. Owing to its self-sustaining design, the device architecture supports robust field operation in power-limited environments, including remote regions, emergency response scenarios, or travel conditions.

In another embodiment, the invention provides an enhanced solar architecture. The solar panel may be detachable for independent positioning, foldable for compact storage, deployable through articulated joints, or mounted on a multi-axis hinge or spherical bearing to enable solar tracking. These configurations allow users to reposition the panel for maximum exposure to available light. The battery may be thermally coupled or co-encapsulated with the solar panel, forming a hybrid integrated structure that optimizes energy density per unit volume and is suitable for compact, wearable, or handheld devices. The articulated mounting system may include pivot arms, telescopic tracks, or rotational bearings that permit manual or automated orientation of the solar panel.

The device may also include the docking interface configured for alignment with a solar charging base, where the docking station may itself include a larger auxiliary solar panel for supplemental charging. Smart logic circuitry, manages energy flow within the system, prioritizing solar input when ambient light conditions are sufficient, disabling non-critical operations when light levels are inadequate, and transitioning seamlessly to auxiliary energy storage when necessary. This intelligent management and use of MPPT ensures stable and efficient energy utilization under varying environmental conditions.

In another embodiment of the invention provides an articulated solar docking station. The docking station includes a base configured to hold one or more portable devices, and, a solar panel mounted to an articulated support structure i.e., a base, a charging interface that may be wired, magnetic, or inductive, and an optional energy storage unit for deferred charging. The articulated mounting system, may utilize a spherical bearing, multi-axis gimbal, or flexible frame that enables manual or automated repositioning of the solar panel to track sunlight throughout the day. The docking station is capable of supporting multiple devices through different interfaces and incorporates a charge routing module that dynamically allocates power based on device priority or charge status.

An internal battery within the docking station, enables off-grid functionality, while a power management controller regulates energy transfer among the solar panel, internal battery, and connected devices. MPPT control mechanisms may be used for maximum solar exposure. The docking station supports a wide range of devices including toothbrushes, trimmers, remote controls, wearables, phones, and tablets. Optional enhancements may include detachable solar panels, swappable rechargeable batteries, multi-voltage output systems, and programmable charge controllers that prioritize solar, grid, or stored energy inputs based on user-defined logic parameters.

In a further configuration, the invention may provide a solar-only device without any wired charging interface. The device includes a solar panel optimized for ambient lighting, a thin-profile energy storage component, and a power management circuit designed to exclude external power connections. This configuration enables operation entirely on solar energy, supporting sealed or port-free device designs suitable for environments where durability, hygiene, or water resistance is critical. Adaptive behaviour logic, automatically suspends non-essential functions during low-light conditions, engages low-power standby modes, or generates user alerts when energy availability decreases. The solar panel and energy storage unit may be co-laminated or co-encapsulated into a single structure, to reduce thickness, enhance rigidity, and improve structural efficiency.

Such devices, may include smartphones, sensors, grooming tools, wearable devices, or keychain-based personal safety devices. In certain embodiments, the exclusion of wired charging ports simplifies manufacturing, minimizes failure points, and improves long-term reliability. The overall system thus demonstrates a high degree of autonomy and robustness suitable for modern portable electronic applications.

The present invention therefore provides a unified platform of solar-powered solutions that enable fully or partially solar-driven operation across diverse device classes. It supports deployable or detachable solar panels for enhanced energy capture, eliminates reliance on wired charging in select configurations, and integrates intelligent fallback and energy prioritization logic. These advancements collectively enhance autonomy, resilience, and environmental sustainability, while facilitating modular product families adaptable for both consumer and industrial applications.

In another embodiment herein, the invention presents novel architectures and systems for solar-powered portable electronics. By integrating flexible solar panel deployment mechanisms, thin-profile energy storage systems, articulated docking stations, and adaptive logic, the invention enables next-generation mobile devices that function sustainably and reliably across a range of operating environments with minimal user intervention and maximum energy efficiency.

In certain embodiments, the spherical joint includes a low-force breakaway mechanism, configured to disengage upon application of force exceeding a defined threshold, thereby preventing mechanical stress or damage to the panel system or attached device. The joint may employ spring-loaded contacts, magnetic couplings, or snap-fit features to provide both electrical continuity and mechanical articulation under normal use, while allowing safe disconnection in the event of accidental impact or overload. Protective outer elements such as flexible bumpers, elastomeric rings, or energy-dampening inserts may also be included to absorb shock and prolong the lifespan of the assembly.

Statement Regarding Drawings: The drawings are provided for purposes of illustration and to show various possible combinations of inventive features. It should be understood that the invention is not limited to the specific embodiments shown, and that features described or illustrated in connection with one embodiment may be combined with features of other embodiments as defined by the claims. The minimum inventive concept resides in the features recited in the claims, whether presented singly or in combination.

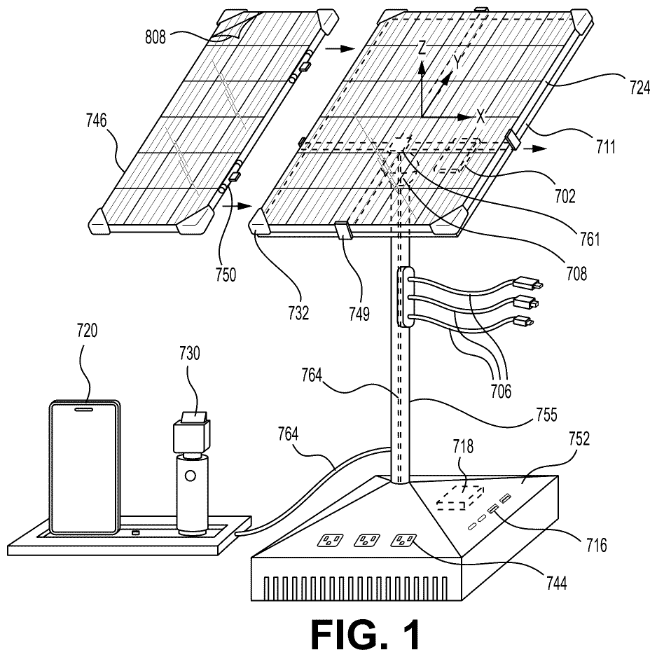

### FIG. 1—Embodiment: Solar Docking Station

Referring now to FIG. 1, a solar-powered docking station 707 with an electromechanically operative pass-through hinge 736 that supports an integrated and optionally detachable solar panel 724 disposed on an exterior surface. The solar panel is electrically coupled to an onboard rechargeable battery 711 and, in certain embodiments, to an optional uninterruptible power supply (UPS) 752. The UPS may include internal AC outlets 744, DC ports 716, and buck-boost converters 702 within a power-management subsystem 740 to provide regulated outputs across multiple voltage levels. For the modular attachment panel, a breakaway electromechanically operative modular hinge 750 allows for low force detachment to prevent damage.

In one embodiment, the panel is mounted to the docking station via an articulatable spherical bearing or ball hinge 708 having an electrically operative pass-through, enabling continuous electrical connectivity through a full range of motion. The bearing optionally provides multi-axis positioning to optimize solar exposure.

In various configurations, the device further includes modular expansion panels attachable through low-force electromechanically operative breakaway connectors 748, permitting scalable generation capacity. The docking station may incorporate protective coatings 808 and shock-absorbing bumpers 732 to resist impact and environmental degradation. Multiple DC and data ports, and various dc power cords 706 allow for charging at varying voltages. Power regulation and switching logic, as described in FIGS. 18-21 and 23-24, allow the device to function as a power hub or docking interface for external electronics.

In certain embodiments, the solar-powered docking station operates as a hybrid AC/DC power platform, with the UPS providing emergency or uninterrupted operation. Optional status indicators or user interfaces may display charging state, active source, or fault conditions. Other embodiments may incorporate wireless data modules or telemetry components to monitor energy status remotely.

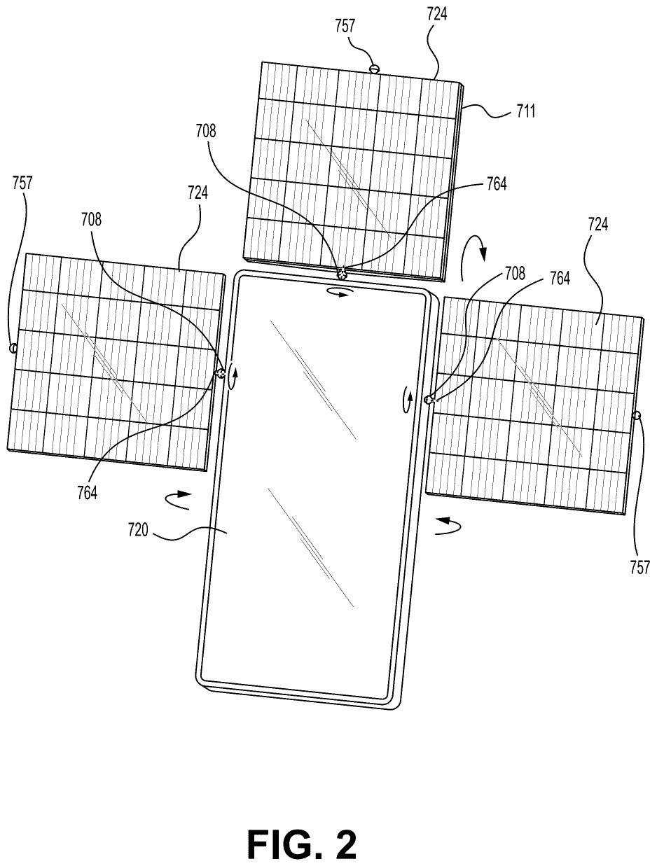

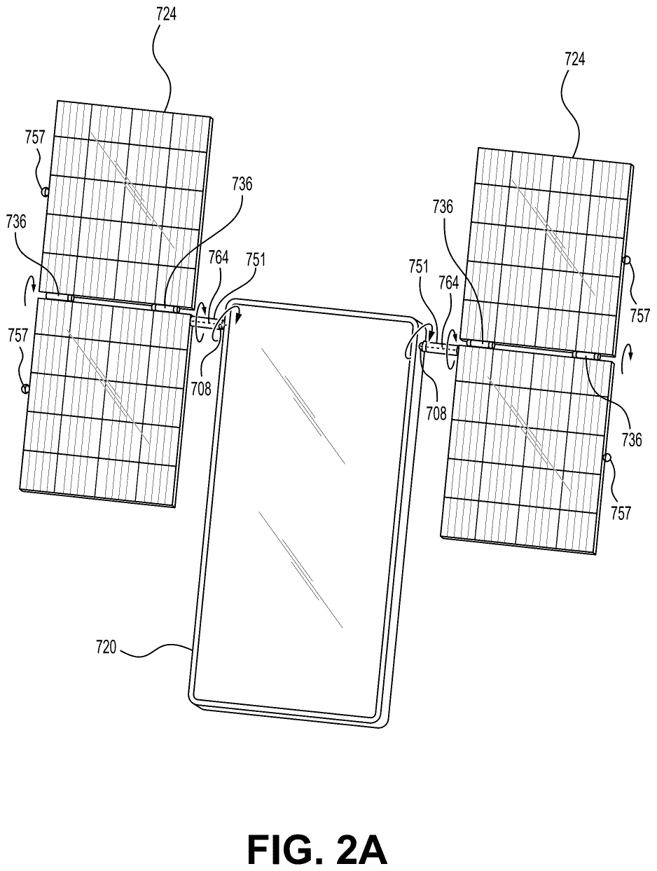

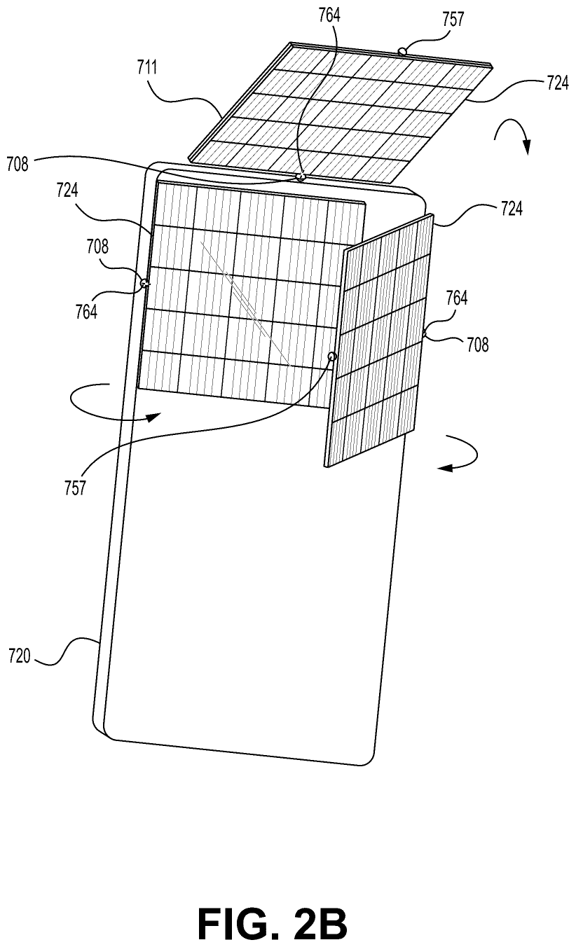

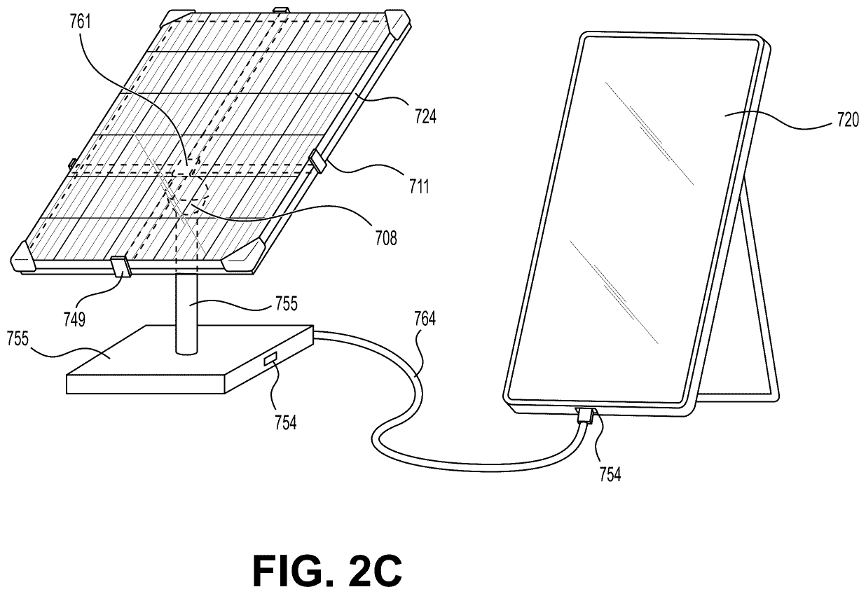

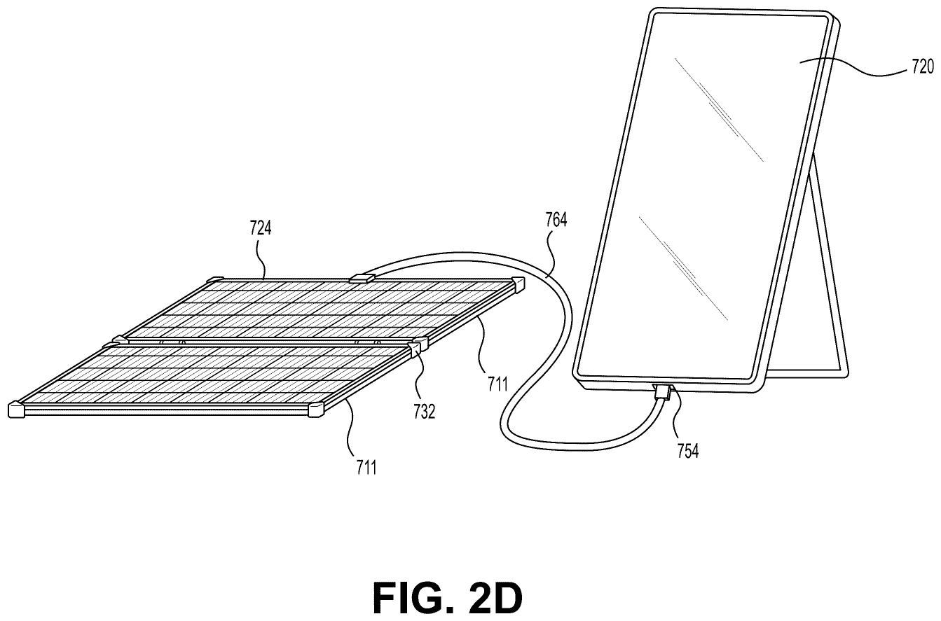

FIG. 2—Mobile Phone with Detachable Articulating Solar Panels

Referring now to FIG. 2, a portable device 720 (or similar handheld electronic device) is shown incorporating three detachable solar panels mounted via articulatable spherical bearings that include electrically conductive pass-throughs. Each panel may optionally connect through a low-force breakaway connector 748 which is electrically operative, enabling rapid detachment under stress or user intent while preserving electrical continuity during normal operation.

In some embodiments, the panels are foldable into the device housing to form a compact stowed configuration, and have a thin battery 711 attached to the panel, while in others, the panels articulate outward to maximize solar exposure. Protective shock absorbing impact bumpers are placed on edges or corners of panels 732 and coatings 808 may be provided to improve durability.—

As with FIG. 1, the modular structure allows cross-compatibility of panels and connectors among multiple device types, simplifying manufacturing and interchangeability.

### FIGS. 2-2D—Modular Solar Attachment Panels:

Referring to FIG. 2, a portable device includes 3 solar panels 724 top left and right of device mounted on spherical bearings 708. Mounted to device on electromechanically operative spherical bearings. In FIG. 2A same device is mounted on low force breakaway folding and sliding hinges 751 that enable folding between stowed and deployed positions. The hinge further allows for passthrough of cable 764 to transmit power. In FIG. 2B, the panels are being folded into a pocket on the back of the device flush with the device housing for compactness. In FIG. 2C, the panels have been detached and mounted on a detachable panel stand 755. The panel stand has a spherical bearing or hinge partially to allow for multi-axis articulation. Panel is attached with an adjustable clamp arm assembly having an operative spherical bearing mount 749. The panel may be optionally mounted on a detachable mounting assembly 761. This allows for safe attachment and articulation of various panel sizes. In FIG. 2D, the panels are fully unfolded and detached to maximize exposure to ambient light. Electrical cale 764 maintain continuous charging connectivity.

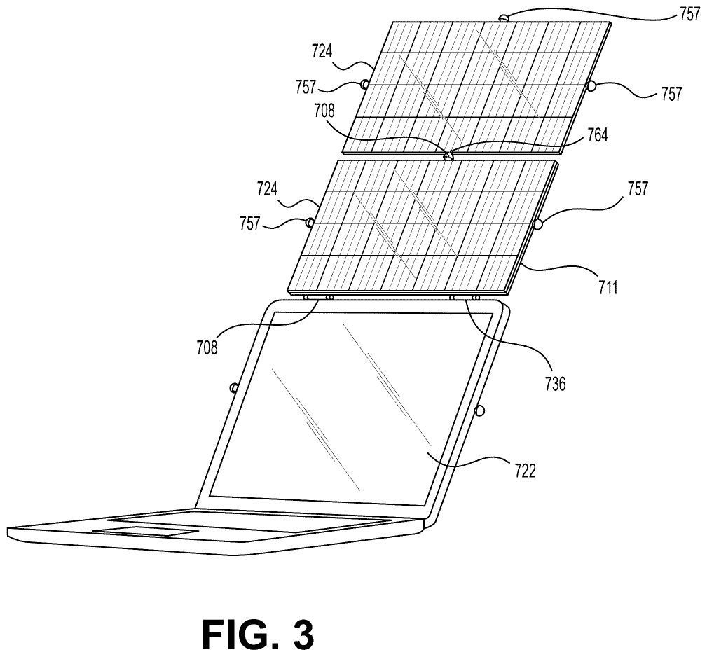

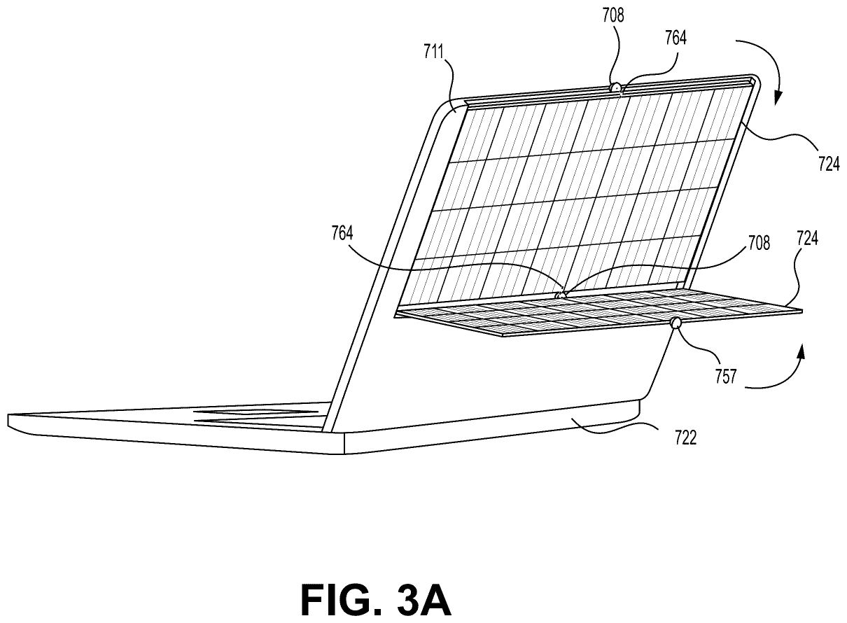

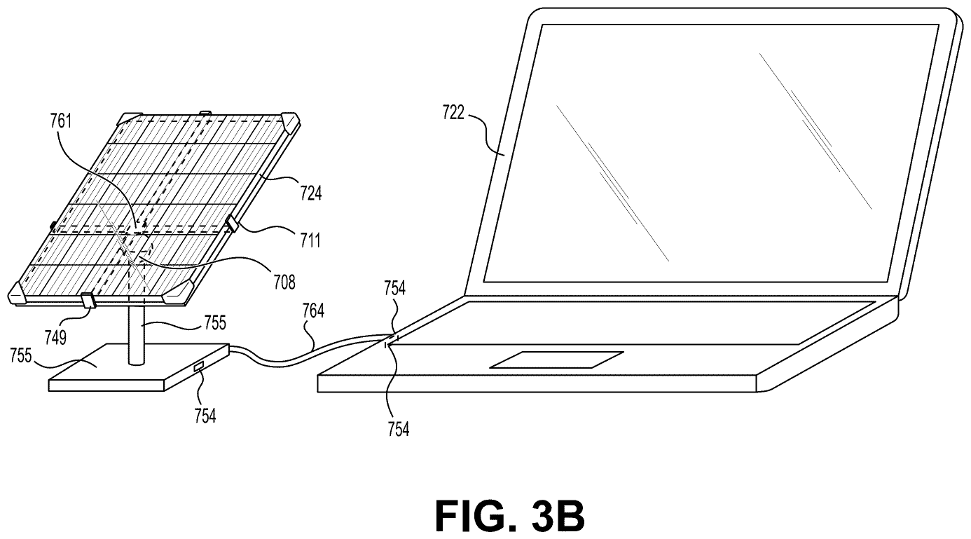

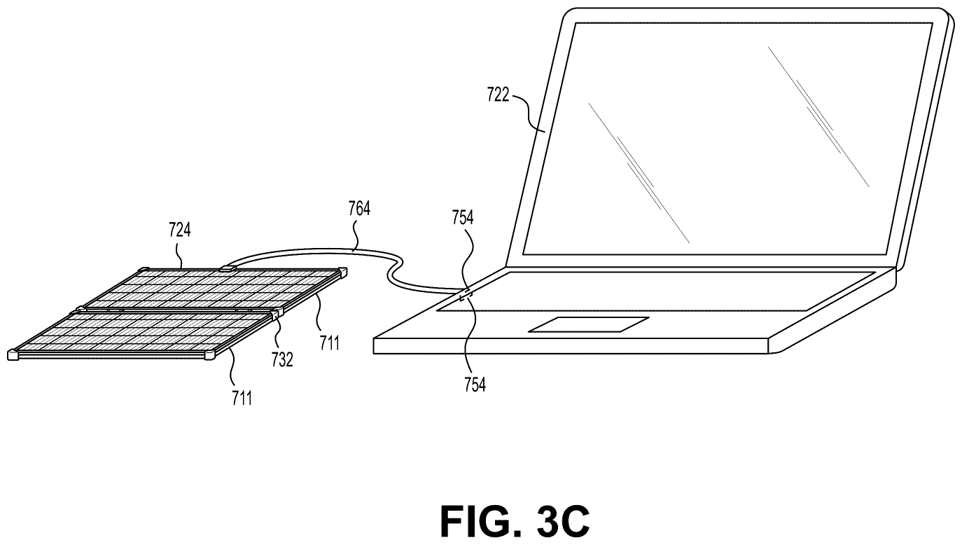

FIG. 3-3C—Laptop with Secondary Solar Panel

Referring now to FIG. 3, a laptop computer 722 is depicted that includes solar panel 724 mounted to the lid or rear surface thereof. A secondary solar panel is attached via electromechanically operative spherical hinge, providing additional surface area for energy capture. The hinge 708 may include electrical pass-through conductors enabling both mechanical articulation and active energy transfer.

In certain FIG. 3A embodiments, the secondary panel folds flat into a pocket on rear of device housing for transport or storage, and may be detachably removed for independent positioning. An integrated battery and power-control hardware manage the panels output for device charging and operation.

In FIG. 3B and FIG. 3C The laptop is shown in analogous alternate views to those described for the mobile device of FIG. 2 showing detachable panels mounted on a stand with spherical bearing mount and another view with panels detached and lying on a flat surface. These panels have a thing film battery 711 for storage. Optionally the panels include additional DC input/output ports.

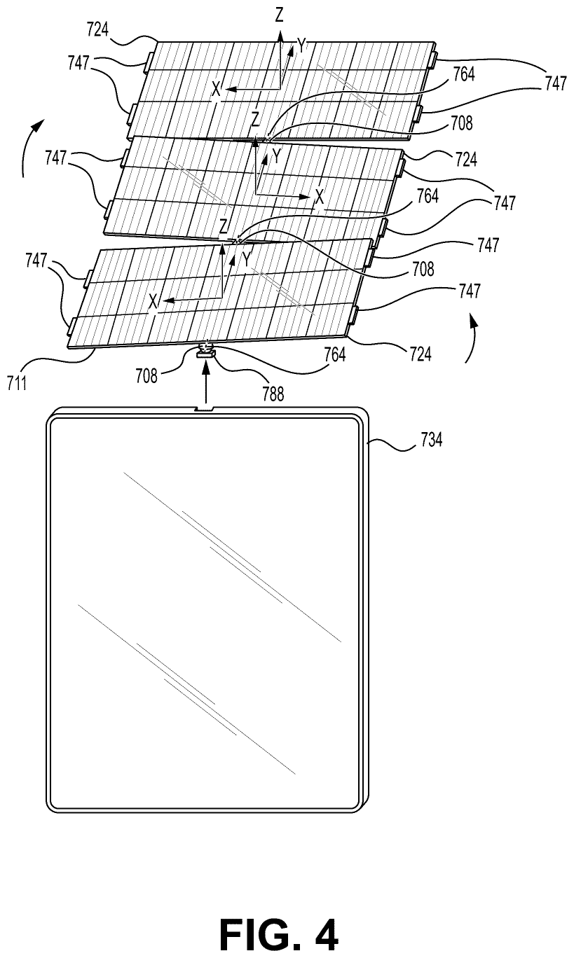

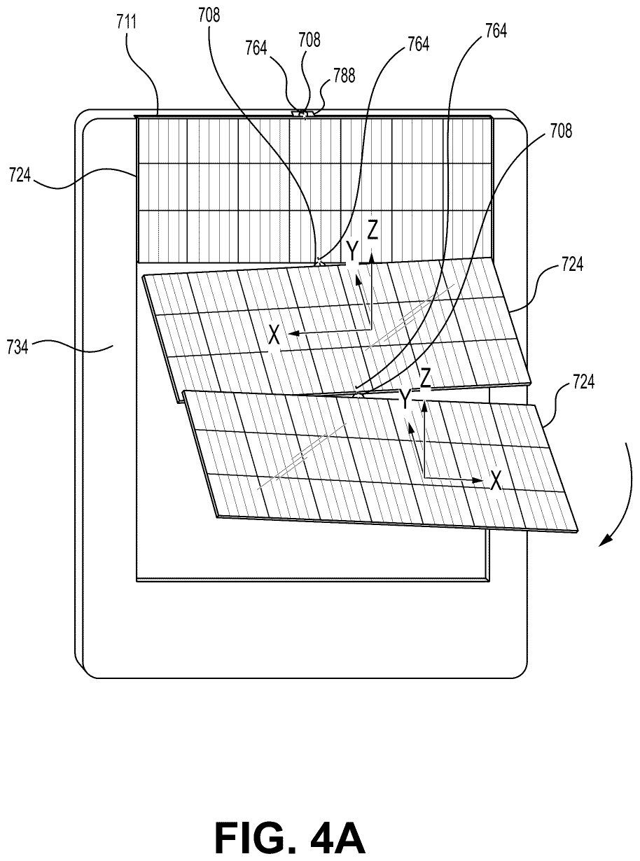

FIG. 4—4A Tablet with Multiple Modular Panels

Referring now to FIG. 4, a tablet computer and a plurality of modular solar panels 724 coupled via electrically operative and articulatable spherical bearings 708. Each spherical bearing allows independent angular adjustment of its corresponding panel, and each panel may include its own thin battery 711. In some embodiments, panels may detach completely and re-dock magnetically or via low-force breakaway connectors 748.

Now in FIG. 4A—a rear view is shown with the panels 724 folding into the back surface of the device. The tablet 40 thus benefits from scalable surface area for solar harvesting while retaining a compact, portable configuration. In FIG. 4A, The panels can pivot about axes X, Y, Z and fold into device.

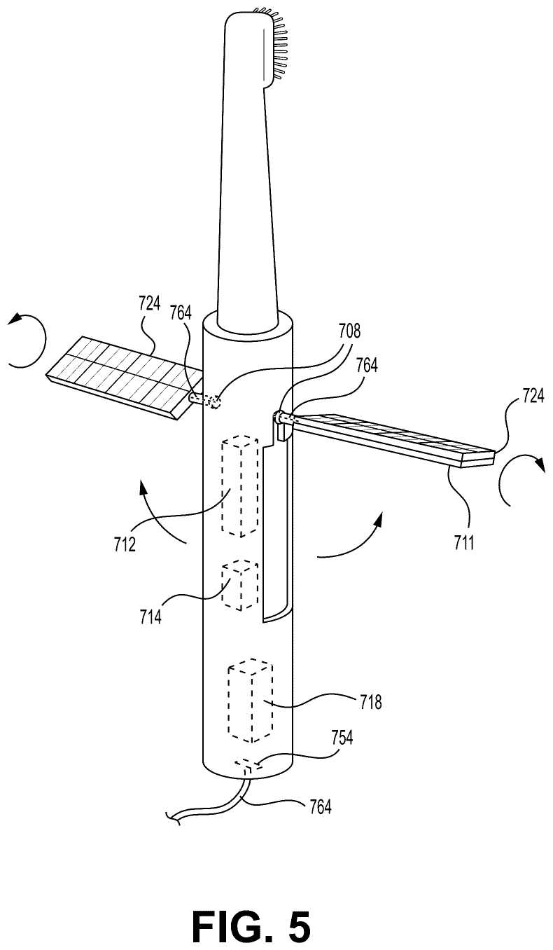

### FIG. 5—Solar-Assisted Toothbrush

Referring to FIG. 5, an oral-care device such as a powered toothbrush 738 incorporates a thin battery 711 electrically coupled to an exterior solar panel 724 disposed along the handle or base. In certain embodiments, the battery 712 serves as a reserve cell maintaining operation when ambient light is limited. The panel 724 may be flush or detachable via a low force electrically operative break-away connector 748. Control logic regulates input charging voltage and manages over-charge protection. The arrangement allows essentially indefinite operation without manual recharging or battery replacement.

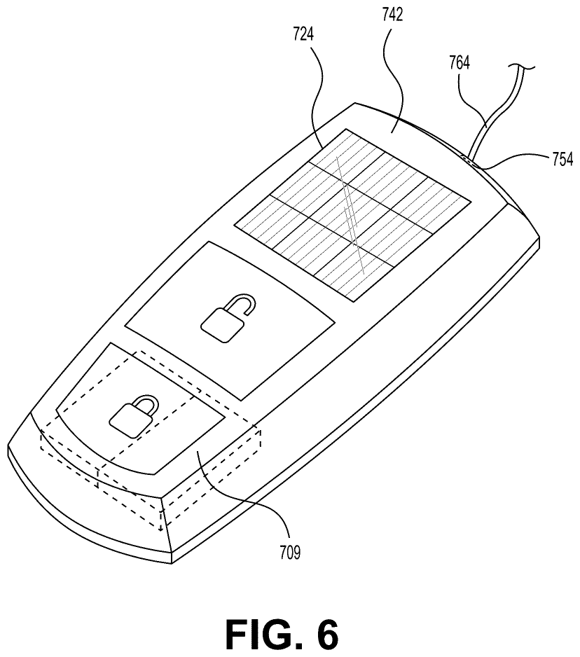

### FIGS. 6-8—Self-Charging Small Devices

Referring to FIG. 6, a key-fob 742 includes a solar panel 724 laminated into an upper housing surface, charging an internal rechargeable battery 712. In certain embodiments, this configuration entirely eliminates disposable coin cells.

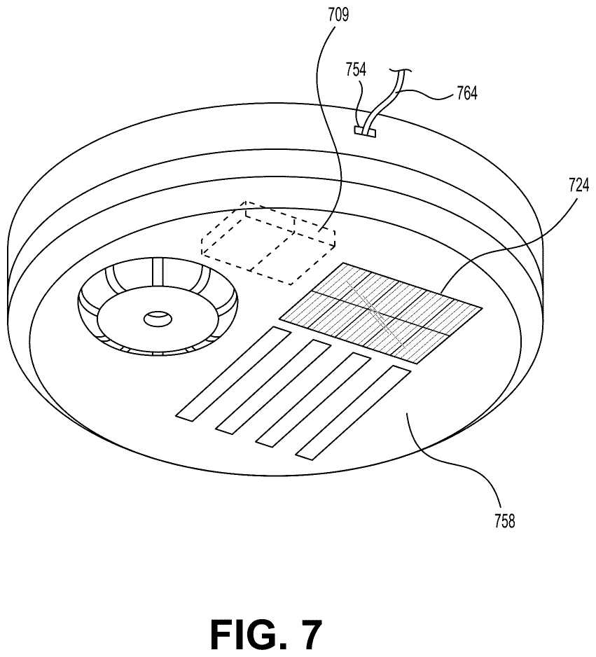

Referring to FIG. 7, a smoke detector 758 incorporates similar components, battery, 712, and solar panel 724 enabling autonomous power maintenance for sensing electronics.

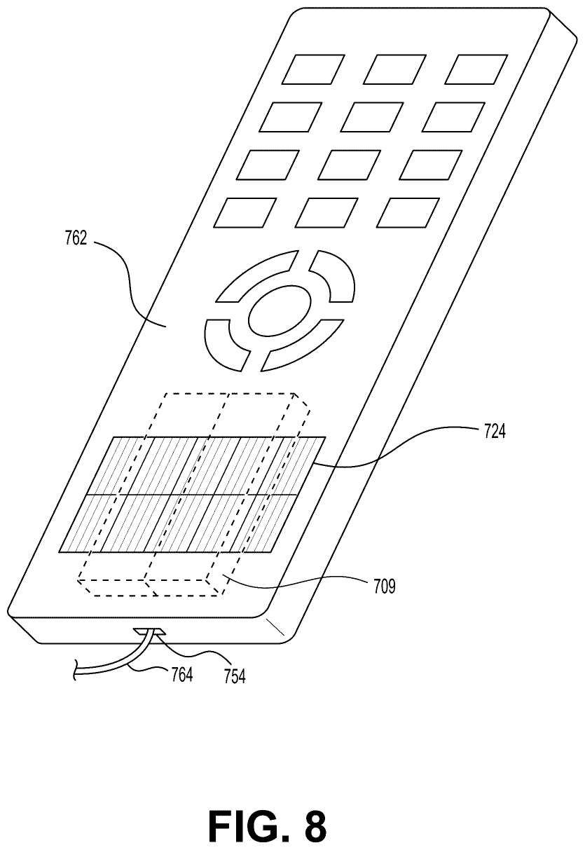

Referring to FIG. 8, a handheld remote control 762 employs the same solar-battery arrangement, Across FIGS. 6-8, the internal logic 740 performs charge regulation consistent with that described in connection with FIGS. 18-19 and FIGS. 23-24.

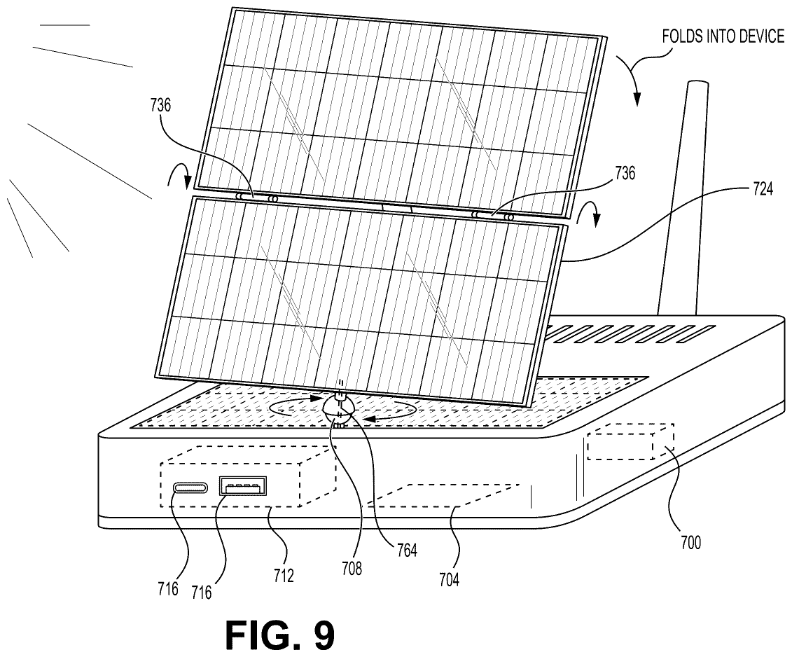

### FIG. 9—Solar-Powered Router

Referring to FIG. 9, a router or network hub 700 includes internal circuitry 704 a solar panel 724 mounted on an articulatable spherical bearing 708 as noted, that provides both physical support and conductive pass-through to the internal battery 712 and power logic 740. A modular expansion panel 724 may be attached by a simple hinge or breakaway connector 748. Multiple DC charging ports 716 are available.

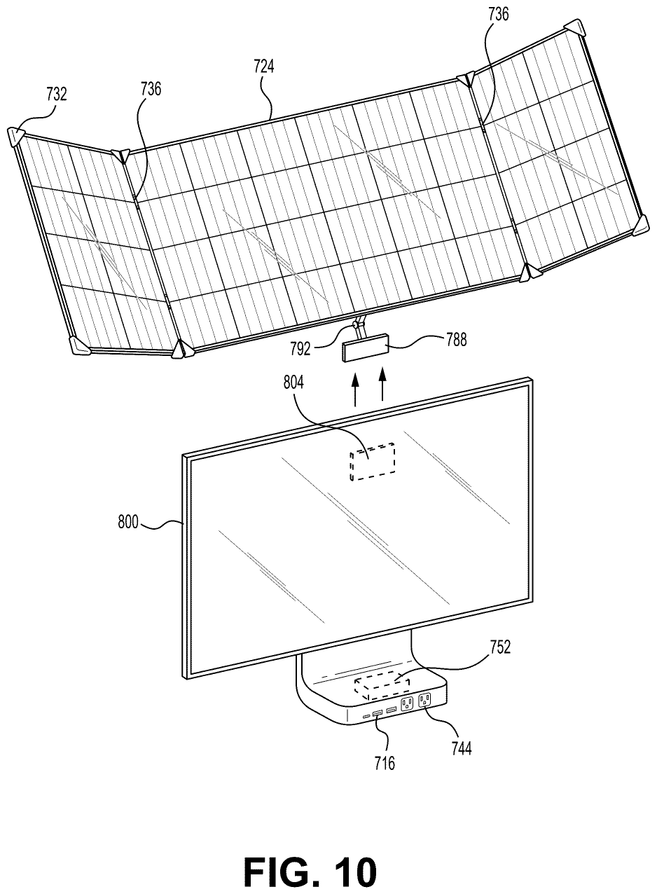

### FIG. 10—Display Monitor

Referring to FIG. 10, a display monitor, 800 incorporates a solar panel 724 mounted to the device via a linear hinge 708 that includes conductive paths for direct charging of an internal battery 712. An integrated UPS 752 supplies both AC outlets 744 and DC ports 716 to connected peripherals. In some configurations, logic 740 prioritizes solar input and automatically transfers to the UPS 752 upon insufficient solar power. A coating 808 may protect the panel and housing from environmental exposure. A hinge arm 792 is attached to the electrically operative low force breakaway hinge arm adapter. Display internal circuitry 804 is in the device. Panels in this device are electromechanically operatively connected with a single axis hinge 736.

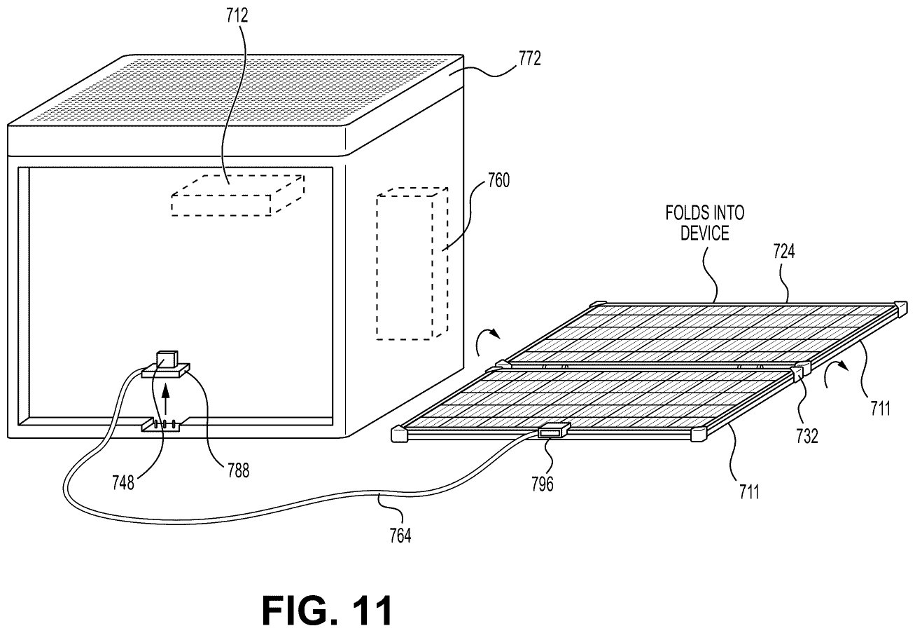

### FIG. 11—Breakaway Hinge and Remote Panel

Referring to FIG. 11, a wireless speaker 772, an embodiment is shown with a low-force breakaway hinge 788 attached via an adaptive low force breakaway connector 748. The electromechanically operative hinge is attached to a flexible cable 764, allowing the embedded solar panel 724 to be detached and positioned separately for optimal sunlight capture. The figure also depicts multiple panels 724 foldable into the host device for compact storage. This configuration permits hybrid operation—attached, detached, or folded—as user conditions dictate.

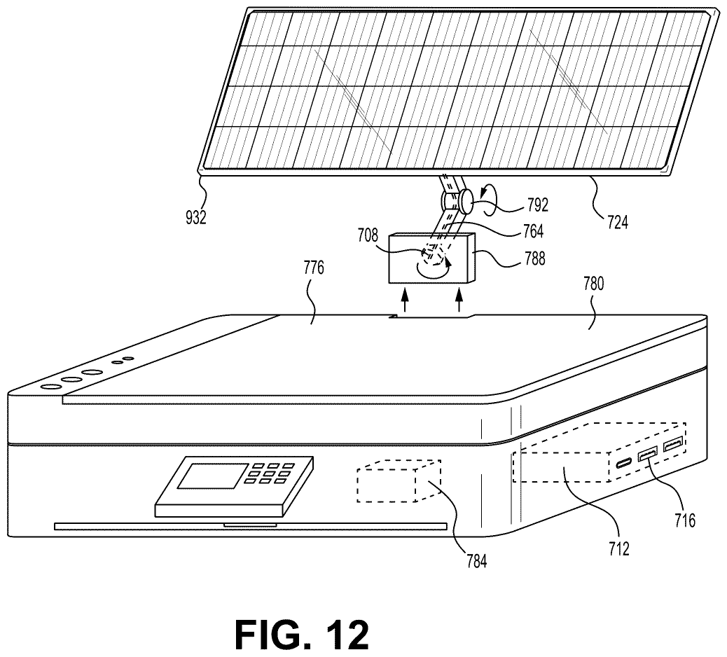

FIG. 12—Printer with Articulating Solar Mount

Referring to FIG. 12, a printer/scanner device 776 includes a solar panel 724 mounted on an articulating hinge arm 792 that enables orientation toward a light source while maintaining electrical connection. The hinge arm 792 may terminate in a low-force breakaway connector 748/796 for safe detachment. The printer includes DC charge ports 716 powered by an onboard battery 712 and power-control hardware 784 managing charging and distribution.

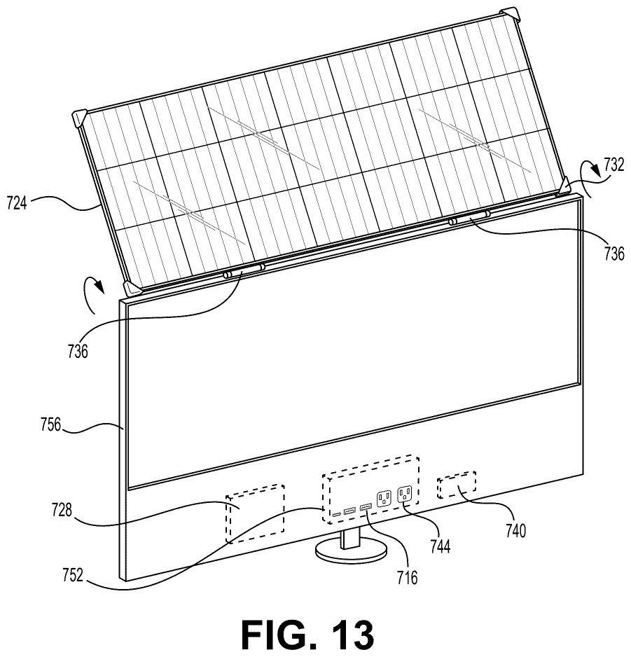

### FIG. 13—Smart Television

Referring to FIG. 13, a smart television 756 with internal circuitry 728 integrates a solar panel 724 on its rear or upper housing 736, with internal UPS 752 circuitry providing AC/DC conversion and backup. In certain embodiments, the solar panel 724 may power standby logic or sustain low-power operation. Other configurations allow extended off-grid operation using the same modular panel system described previously.

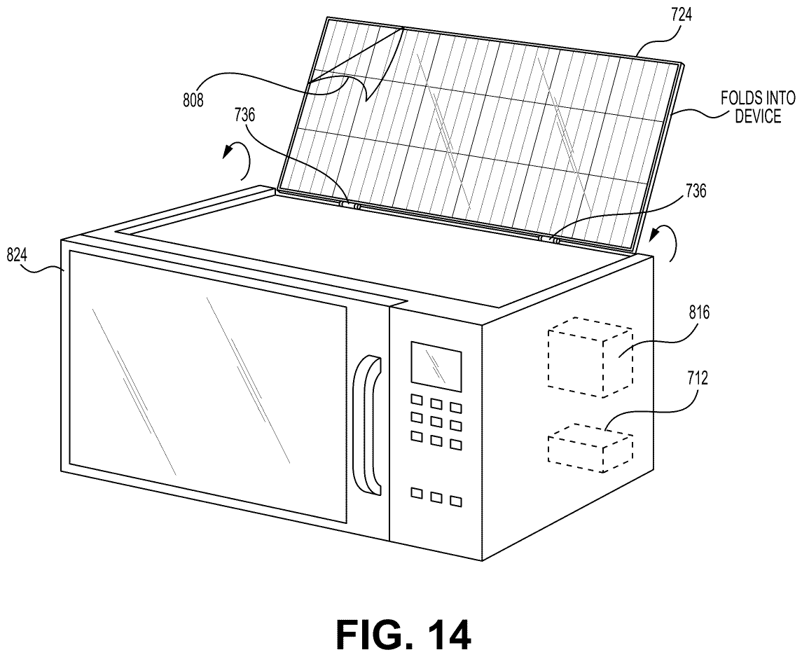

### FIG. 14—Microwave Oven

Referring to FIG. 14, a microwave oven 824 includes a hinged solar panel 724 mounted on the housing 736 and coupled to an internal battery 712 and UPS 752. The hinge allows repositioning to optimize light capture. Power regulation logic 740 supplies the heating element 816 and control electronics during outages, optionally supplementing mains AC input. Protective bumpers 732 shield the hinge mechanism and panel edges from impact.

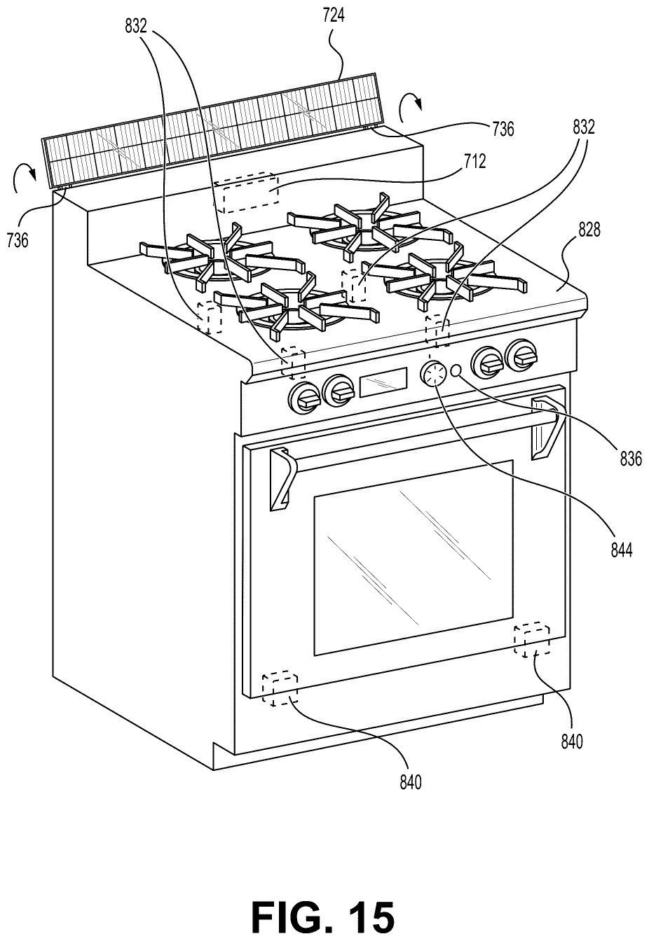

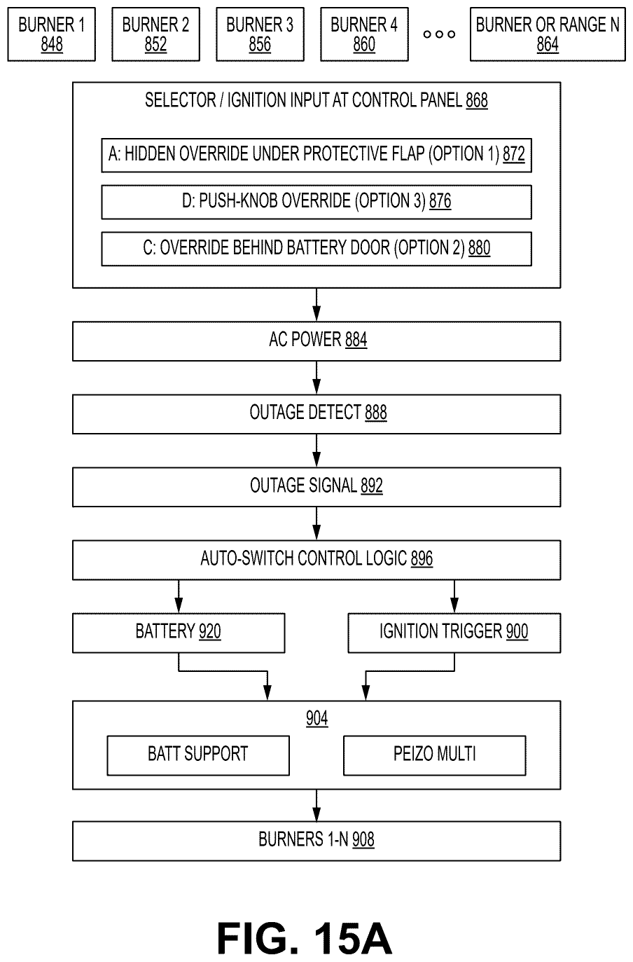

FIGS. 15 and 15A—Gas Range with Battery and or Solar-Assisted Ignition

Referring to FIG. 15, a gas range or cooktop 828 includes a solar panel 724 and battery 712 providing electrical energy to ignition components 832 and 840. In certain embodiments, the range further includes manual push-button igniters 836 and logic 896 configured to detect mains-power loss and automatically switch to battery-powered ignition. An 844 manual selector allows selection of which piezo gets battery or push button power. Optional piezo elements 904 may act in concert or redundancy with electronic ignition.

Referring to FIG. 15A, control logic 896 receives an outage-detect signal 888 and switches to battery ignition trigger 900 when AC input 884 is interrupted. Overrides 872-880 permit manual activation paths. This arrangement ensures continued functionality during power outages while maintaining user safety.

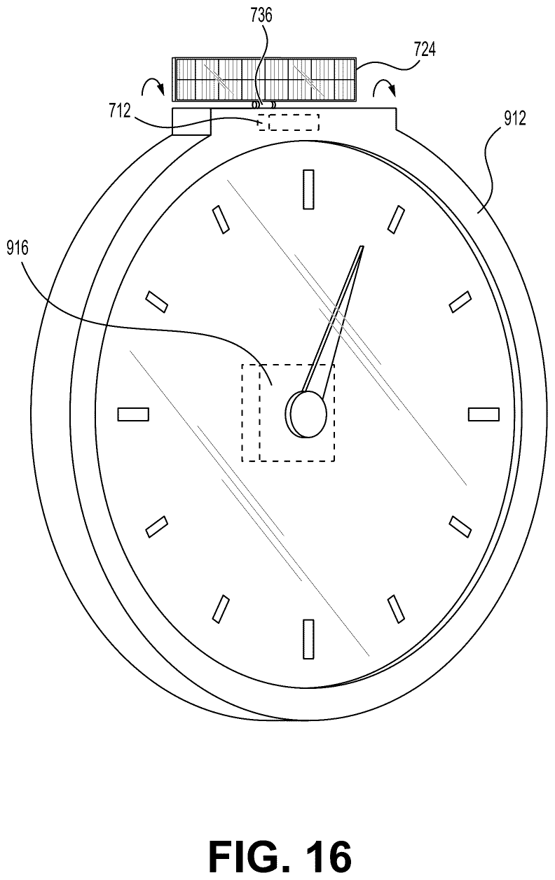

### FIG. 16—Solar-Powered Clock

Referring to FIG. 16, a wall clock 912 includes a housing 736 carrying a solar panel 724 that maintains charge in a rechargeable battery 712. The battery supplies power to the clock mechanism 916. In certain embodiments, surplus charge may be available to auxiliary devices through a low-power output port 716. This embodiment effectively eliminates battery replacement cycles.

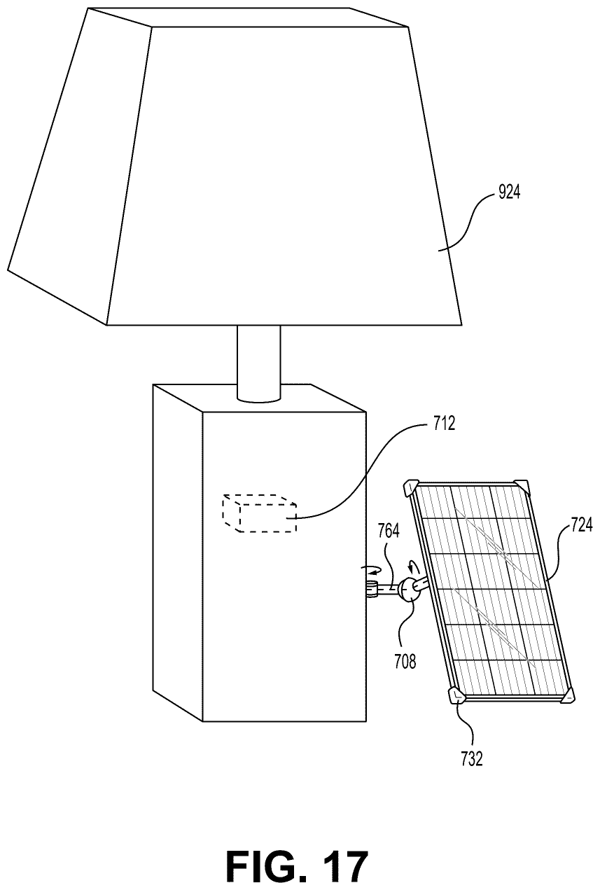

### FIG. 17—Solar-Integrated Lamp

Referring to FIG. 17, a lamp 924 includes a solar panel 724 mounted on an articulating hinge arm 792 attached through a spherical bearing 708 providing conductive pass-through. The hinge arm 792 allows the panel to fold seamlessly into the lamp body for compactness or extend outward for optimized illumination capture. An internal rechargeable battery 712 stores energy to operate a light source via power logic 740. Protective bumpers 732 and coatings 808 may be included for durability.

### FIGS. 18 and 18A—Solar Power Controller Systems:

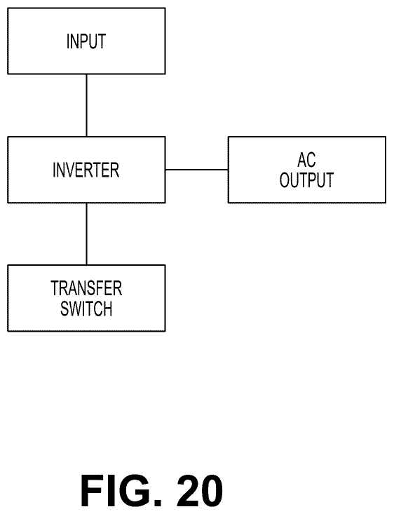

Referring to FIGS. 18 and 18A, a solar controller manages current flow between a solar panel input, an external DC/AC battery interface, and internal device power circuits. FIG. 20A shows an alternate embodiment including modular connectors for detachable solar modules and regulated DC voltage output. Both embodiments include power conditioning, reverse-current protection, and automatic switching between solar and stored power sources.

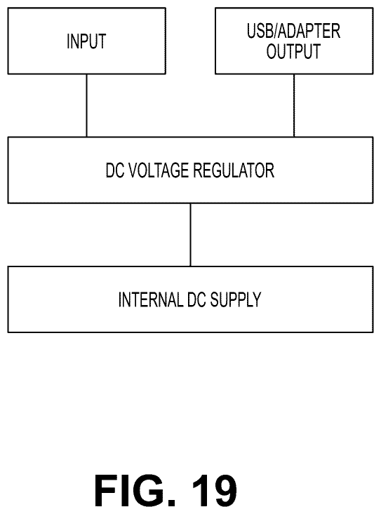

### FIG. 19—DC Voltage Regulation and Internal Supply:

Referring to FIG. 19, input power from either a solar array or an AC-to-DC adapter passes through a voltage regulator configured to maintain a consistent internal DC bus. The circuit includes a voltage sensing feedback loop and protection diodes to prevent reverse current. An internal DC supply distributes regulated power to sub-systems such as charging controllers, logic boards, and peripheral ports. The configuration allows uninterrupted operation when transitioning between external power and stored energy sources.

### FIG. 20—Inverter and Transfer Switch System:

Referring to FIG. 20, an inverter and transfer switch system is shown. DC power from the onboard battery or solar controller is supplied to an inverter configured to produce AC output. A transfer switch automatically selects the active power source—solar input or battery backup—to maintain uninterrupted AC supply. Overload and phase-monitoring circuits protect connected loads and enable smooth switchover during hybrid operation.

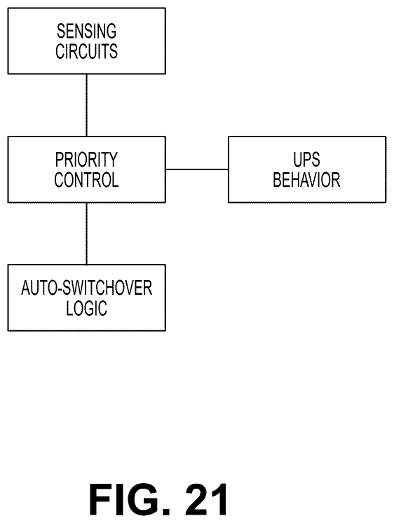

### FIG. 21—UPS and Control Logic Circuitry:

Referring to FIG. 21, a UPS and control logic subsystem is illustrated. Control circuitry monitors voltage, current, and illumination through sensing elements and executes power-priority protocols. The UPS module manages automatic transition between solar and stored energy to sustain continuous operation. Priority control allocates power between external loads and internal storage based on charge status, while energy-saving modes and user alerts activate under low-capacity conditions.

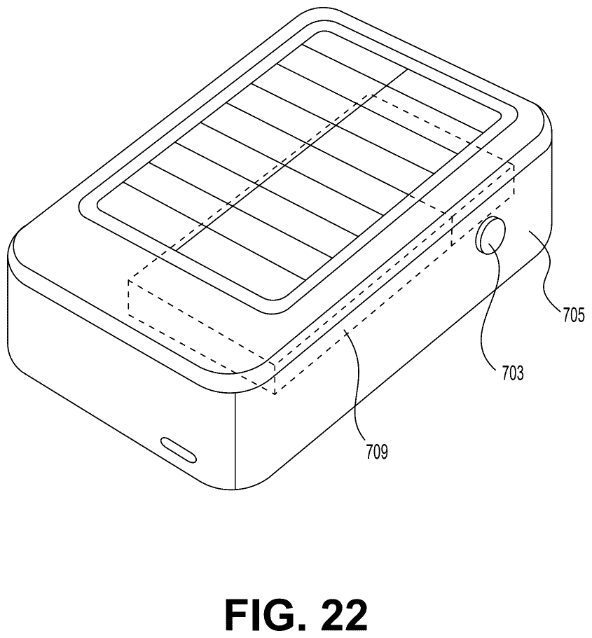

### FIG. 22—Device System Overview:

As shown in FIG. 22, the device includes a main power bus 705, solar input 709, and system controller 703 integrated within the chassis. The solar interface connects directly to the controller, which regulates charging and distributes power to internal modules. This configuration supports compact, efficient integration of power-management functions within portable devices.

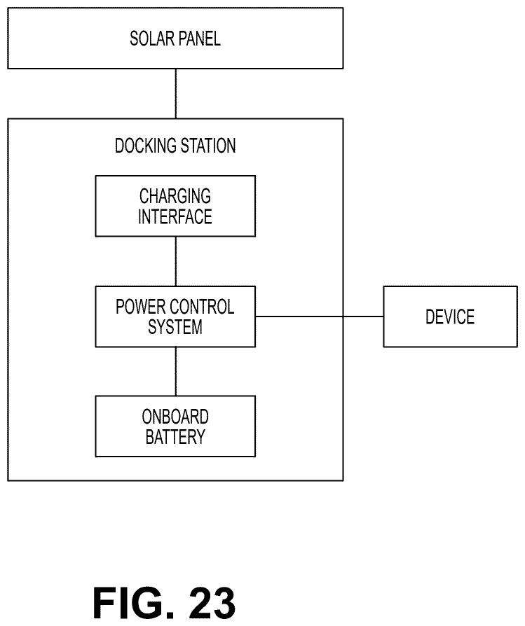

### FIG. 23—System Power Architecture:

Referring to FIG. 23, a system-level power architecture is depicted. The docking station includes a solar panel, power-control subsystem, charging interface, and onboard energy storage. The internal controller manages energy flow between solar input, stored energy, and external devices, prioritizing charging or load support according to available power. The arrangement enables autonomous and balanced operation across varying conditions.

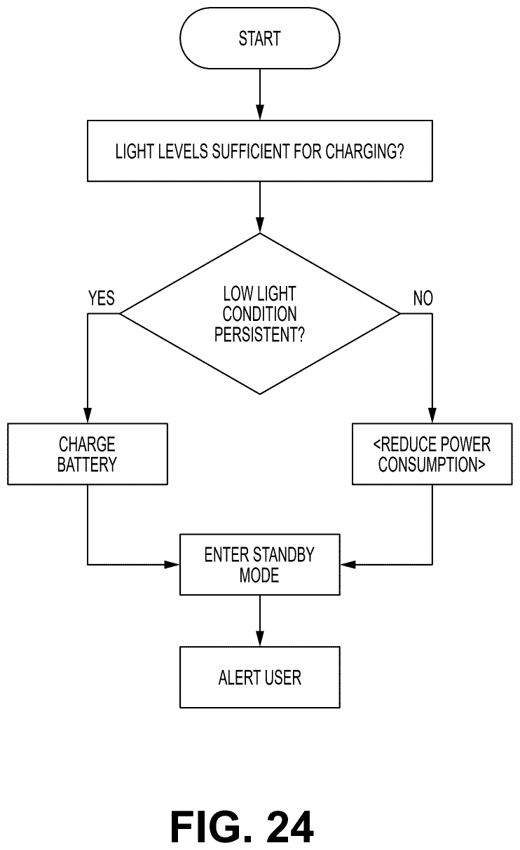

### FIG. 24—Solar-Charging Flowchart:

Referring to FIG. 24, a flowchart illustrates the solar-charging control sequence. The controller detects ambient light and begins charging when illumination exceeds a threshold. If light falls below the threshold, the system reduces power consumption and enters standby mode. Charging resumes automatically when sufficient light returns, while persistent low-light conditions trigger extended power-saving routines to preserve stored energy.

Collectively, these figures illustrate representative non-limiting embodiments of solar-integrated devices, docking systems, and power-management architectures that provide renewable energy supplementation and uninterrupted operation under varying light conditions.

Features described with respect to any particular embodiment or figure may be incorporated into any other embodiment or figure. The order and combination of features is not limited to that explicitly shown or described, and modifications, substitutions, and variations are intended to fall within the scope of the invention as supported by the present disclosure.

Referring to FIGS. 18-24, these illustrate various non-limiting logic and control architectures are illustrated. These configurations may be employed, in whole or in part, to enable functionality across a range of device embodiments. The depicted arrangements provide flexible support for solar power integration, battery backup, UPS behaviour, hybrid AC/DC operation, and power management schemes, depending on the requirements of a given application.

In various embodiments, the systems and methods disclosed herein may be configured to support a wide range of mechanical and electrical configurations, allowing for numerous possible combinations and variations of the disclosed features. It will be understood that the embodiments described are illustrative and that many additional arrangements are possible, depending on size, application, and product form factor. For example, a solar panel assembly, docking module, or other deployable energy-harvesting element may be attached, supported, or articulated by one or more hinge assemblies, linkages, or spherical bearings, which may be positioned on, within, or about any suitable portion of a device housing.

In certain implementations, a hinge arm may be mounted on a spherical bearing, or conversely, a panel may be mounted on a spherical bearing that is itself mounted to a hinge or other jointed structure. Mounting locations may include any external or internal surface of the device, housing, frame, or accessory. In some embodiments, the hinge or spherical bearing may be electrically operative, such that it includes conductive elements, pass-throughs, or integrated slip rings configured to transmit electrical power or signal between movable components.

Any hinge, bearing, or coupling mechanism may further include low-force, electromechanical breakaway features configured to prevent mechanical damage under excessive load, similar in concept to certain detachable electrical connectors (e.g., USB, barrel jack, or magnetic couplers) that release prior to mechanical failure. Protective features such as edge guards, bumpers, or anti-scratch coatings may also be included to mitigate impact or abrasion.

The system may include one or more of the following features, individually or in combination:
(i) detachability from the housing;
(ii) foldability relative to, or into, the housing;
(iii) deploy ability via an articulated joint, hinge, or extension mechanism, optionally incorporating a spherical bearing or electrical pass-through;
(iv) protective coatings, bumpers, or edge guards to reduce impact damage;
(v) a hinge or bearing having a low-force breakaway or torque-limited release mechanism;
(vi) integration of maximum power point tracking (MPPT) circuitry; and
(vii) incorporation of thermal management elements, such as a heat sink or conductive substrate. These embodiments are non-limiting and may be combined or interchanged in any suitable manner to produce numerous configurations and product variations. It should therefore be understood that countless embodiments and mechanical architectures are contemplated, including those not specifically illustrated or described herein.

### Advanced Features

In various embodiments, the systems and methods disclosed herein may further include one or more enhancements designed to improve usability, durability, energy efficiency, or integration with additional technologies. These enhancements may be implemented individually or in any suitable combination, and may be adapted to specific user environments or product categories.

For example, the solar panel system may optionally incorporate smart charging indicators, such as visual LEDs or digital displays, to provide real-time feedback regarding charging status, solar input, or battery levels. Additionally, the system may include orientation sensors (e.g., gyroscopes, accelerometers, or light sensors) configured to assist users in optimal panel positioning, either passively (through notifications) or actively (via self-orienting articulation mechanisms).

The hinge and support structures may include thermal management features, such as passive heat sinks or thermally conductive coatings, to maintain panel efficiency in high-temperature environments. In certain embodiments, the system may incorporate a wireless charging module (e.g., Qi-compatible) to allow untethered energy transfer to external devices. Support for USB-C or magnetic power connectors may also be included to provide a flexible and modern interface for charging and data.

The housing and surface components of the panel assembly may include weather-resistant sealing (e.g., IP-rated gaskets or coatings) to protect against water and dust intrusion, thereby improving performance and reliability in outdoor and rugged conditions. In some configurations, the panel system may incorporate self-cleaning surface coatings, such as hydrophobic or dust-repelling films, to improve long-term energy conversion performance by minimizing surface contamination.

To enhance modularity, some versions may allow for field-replaceable panel sections, enabling users to swap damaged or degraded components without replacing the entire unit. Magnetic alignment elements or integrated locking mechanisms may assist with quick deployment, secure positioning, and storage of panels. Furthermore, integrated cable routing channels or cord management clips may be included to reduce clutter and improve handling during transport and use.

Advanced implementations may also include dual-sided (bifacial) solar cells, capable of harvesting reflected sunlight from secondary surfaces, as well as energy-harvesting elements that capture ambient motion or vibration energy to supplement charging. Flexible or curved solar panels may also be utilized to conform to non-planar surfaces or wearable applications.

In addition, the system may feature auto-locking hinges designed to resist unintended movement due to wind or vibration, and embedded emergency lighting, such as LED flashlights or signalling beacons, for outdoor or survival-oriented use cases. Optional wireless connectivity (e.g., Bluetooth or Wi-Fi) may allow users to monitor and control panel behaviour via mobile applications, further improving the system's usability and energy management capabilities.

These enhancements are presented by way of example and are not intended to be limiting. Any of the above-described features may be implemented in various combinations depending on the application, user preferences, and form factor requirements.

The claimed invention is:

1. A portable electronic device comprising:
(a) a housing; and
at least one of a
(b) a solar panel integrated into or affixed to a surface of the housing and configured to convert ambient light into electrical energy; and
(c) a battery or energy storage component electrically coupled to the solar panel and configured to receive and store energy generated by the solar panel for use in powering one or more components of the device.

2. The device of claim 1, wherein the device is a portable, battery-powered or rechargeable electronic device configured for user handling or mounting, including but not limited to:
(a) a smoke detector or gas sensor;
(b) a personal grooming device including an electric toothbrush;
(c) a remote-control device, key fob, or garage door opener;
(d) a wearable tracking device;
(e) a flashlight or handheld utility tool; and
(f) a personal computing device or cases for such devices.

3. The device of claim 1, further comprising:
(a) an audible or visual alert mechanism powered by the stored solar energy; and
(b) a control circuit configured to limit functionality to critical functions when stored energy falls below a predefined threshold.

4. The device of claim 1, further comprising a status indicator configured to display one or more of:
(a) current charge level of the battery;
(b) solar charging status; or
(c) power source currently in use.

5. A portable electronic device comprising:
(a) a housing;
(b) a battery integrated into the device and or adjacent to the solar panel and configured to receive charging current therefrom;
(c) a charge control circuit configured to direct energy from the solar panel to the thin-profile battery and to selectively power one or more components of the device; and
(d) a solar panel configured to convert ambient light into electrical energy, the solar panel being at least one of:
(i) detachable from the housing,
(ii) foldable relative to the housing and or into the device,
(iii) deployable via an articulated joint or extension mechanism, or mounted on a spherical bearing or hinge, which is optionally operatively configured to transmit electrical current though the hinge,
(iv) protective coatings, bumpers, or edge guards to prevent impact damage,
(v) any of the hinges listed above having a low force breakaway feature,
(vi) having MPPT technology, and
(vii) having a heat sink.

6. The device of claim 5, wherein the portable electronic device is configured to at least one portable electronic device, including but not limited to a device selected from the group consisting of:
(a) a cell phone, laptop, or other mobile device or device case;
(b) a smoke detector or gas sensor;
(c) a personal grooming device including an electric toothbrush;
(d) a remote-control device, key fob, or garage door opener;
(e) a wearable tracking device; and
(f) a flashlight or handheld utility tool.

7. The device of claim 5, wherein the thin-profile battery is:
(a) laminated to a backside of the solar panel;
(b) embedded within a shared encapsulation layer with the solar panel; or
(c) positioned in direct thermal and physical contact with the solar panel substrate.

8. The device of claim 5, wherein the solar panel is mechanically coupled to the housing by one or more of the following:
(a) a spherical bearing;
(b) a hinge, telescopic arm, or foldable frame; or
(c) a mount configured to allow reorientation of the solar panel based on ambient light direction;
(d) expandable in modular increments with plug and play re-attachment;
(e) an integrated electrical pathway through said articulation element;
(f) a releasable coupling mechanism configured to separate under a threshold force;
wherein the joint is configured to maintain electrical continuity during articulation and to detach without damage when subject to excess mechanical stress.

9. The device of claim 5, further comprising:
(a) a docking station or charging base configured to receive and support the device; and/or
(b) a solar panel integrated into the docking station and configured to charge the device when docked.

10. The device of claim 5, further comprising logic configured to do one or more of:
(a) prioritize use of solar power when ambient light exceeds a programmable threshold;
(b) suspend non-critical functions when solar input is below a minimum level;
(c) transition to auxiliary battery power when solar energy becomes insufficient; and
(d) enable system monitoring (efficiency, power voltage temp charge current) via an app.

11. A docking station for a portable electronic device, the docking station comprising:
(a) a base configured to physically receive and support the portable electronic device;
(b) a solar panel mounted to the docking station and configured to convert ambient light into electrical energy;
(c) a charging interface configured to deliver electrical energy from the solar panel to the portable electronic device when docked; and
(d) an articulated mounting system configured to enable repositioning of the solar panel, the mounting system comprising a spherical bearing, pivoting arm, or multi-axis hinge configured to optimize solar exposure.

12. The docking station of claim 11, further comprising:
(a) multiple charging interfaces configured to support more than one type of portable electronic device; and
(b) a charge routing module configured to prioritize or sequence power delivery among connected devices based on predefined criteria.

13. The docking station of claim 11, further comprising:
(a) a battery integrated into the docking station and configured to store solar energy for delayed charging use; and
(b) a power control system configured to manage energy flow between the solar panel, the battery, and the docked device.

14. The docking station of claim 11, further comprising a sensor or logic module configured to:
(a) detect ambient light intensity or orientation; and
(b) automatically reposition the solar panel via the articulated mounting system to improve light exposure.

15. The docking station of claim 11, wherein the portable electronic device is configured to interface with at least one portable electronic device, including but not limited to a device selected from the group consisting of:
(a) an electric toothbrush or oral care device;
(b) a grooming tool including a shaver or trimmer;
(c) a handheld remote or fob;
(d) a utility light or sensor-equipped handheld tool;
(e) a low-profile tracker, wearable, or keychain device;
(f) a cell phone, laptop, or other personal mobile device.

16. The docking station of claim 11, further comprising one or more of the following:
(a) a solar panel that is detachable from the docking station housing and electrically reconnectable via a plug-in or wireless interface;
(b) a rechargeable battery that is removably housed within the docking station and configured to be independently charged or replaced;
(c) a multi-voltage output system configured to support charging of devices requiring different input voltages;
(d) a plurality of connector types selected from the group consisting of USB, USB-C, Lightning, magnetic pins, or inductive coils;
(e) a hybrid power integration module configured to receive supplemental electrical energy from an AC grid or wall adapter; and
(f) a programmable charge controller configured to prioritize power sourcing from solar, stored battery, or grid input based on one or more programmable rules or conditions.

17. The device of claim 5, wherein the device is configured to operate exclusively from energy derived from the solar panel and/or the thin-profile battery, without requiring external power input from a wired charging interface.

18. The device of claim 17, further comprising:
(a) a light detection circuit configured to monitor ambient light levels; and
(b) logic configured to:
(i) suspend non-critical operations when light is insufficient for charging;
(ii) enter a low-power standby mode; or
(iii) trigger a visual or audible alert to notify the user of insufficient light for continued operation.

19. The device of claim 17, wherein the solar panel and the thin-profile battery are integrated into a shared housing, laminate, or encapsulation layer.

20. The device of claim 17, wherein the device comprises or includes, but is not limited to, a device such as:
(a) a mobile phone, laptop, or tablet;
(b) a smoke detector or air quality monitor;
(c) a handheld remote control or key fob;
(d) an electric toothbrush or grooming device;
(e) a compact personal tracker or wearable; or
(f) a standalone sensor-equipped utility device.

21. The device of claim 5, further comprising a hinge assembly including:
(a) a first hinge member and a second hinge member coupled for relative rotation about at least one axis; and
(b) a low-force breakaway mechanism configured to decouple the hinge members when a threshold separation force or torque is exceeded, thereby preventing mechanical damage to connected components.

22. The hinge assembly of claim 21, wherein the hinge assembly comprises one or more of the following features:
(a) an electrical pass-through configured to transmit electrical current or signal between the first and second hinge members during rotation;
(b) one or more conductive elements, slip rings, or flexible interconnects forming at least a portion of said pass-through; and
(c) a mounting configuration adapted to support a solar panel, docking module, or portable electronic device housing.
